(19) United States
(12) Patent Application Publication
(10) Pub. No.: US 2024/0341333 A1
(43) Pub. Date: Oct. 17, 2024

(54) DE-FLAVORED LEGUME FLOURS AND METHODS OF MANUFACTURE

(71) Applicants: CORN PRODUCTS DEVELOPMENT, INC., WESTCHESTER, IL (US); INGREDION PLANT BASED PROTEIN SPECIALTIES (CANADA), INC., Vancouver (CA)

(72) Inventors: Lauren ANDERSON, Bridgewater, NJ (US); Sharon BENDER, Bridgewater, NJ (US); Stella COUTROS-HOFFMANN, Bridgewater, NJ (US); Yadunandan DAR, Bridgewater, NJ (US); Oyelayo JEGEDE, Bridgewater, NJ (US); Marjorie WELCHOFF, Bridgewater, NJ (US); Vishnu MURTHY, Bridgewater, NJ (US); Xavier O'CONNELL, Bridgewater, NJ (US); Canan OZER, Bridgewater, NJ (US); Tushar SHAH, Bridgewater, NJ (US); Roxanna SHARIFF, Bridgewater, NJ (US); Robert SKORGE, Bridgewater, NJ (US); Delong SONG, Bridgewater, NJ (US); Meng XUE, Bridgewater, NJ (US)

(21) Appl. No.: 18/683,823

(22) PCT Filed: Aug. 16, 2022
(86) PCT No.: PCT/US2022/040453

§ 371 Date: Feb. 15, 2024

Related U.S. Application Data
(60) Provisional application No. 63/235,191, filed on Aug. 20, 2021.

(51) Int. Cl. A23L 11/00; A21D 2/36; A21D 13/045; A21D 13/066; A23L 11/30

(52) U.S. Cl. CPC A23L 11/05; A21D 2/362; A21D 13/045; A21D 13/066; A23L 11/31

(57) ABSTRACT

This specification discloses de-flavored legume flour have less intense flavor profiles compared to untreated legume flour. The disclosed de-flavored legume flours have been processed to reduce flavor while minimizing damage to the components to the de-flavored legume flour (compared to an untreated legume flour). The disclosed de-flavored legume flours can be adjusted to have functionality like an untreated legume flour or to have improved function compared to untreated legume flour.

The technology disclosed in this specification pertains to legume flours and more specific legume flours that have been processed to remove unwanted flavors.

Legume are seeds from plants of the family Fabaceae. Legumes are high in protein, gluten free, and are commonly ground to form flour legume flour. To some consumers, legume flours are disfavored for being perceived to have a bitter or raw beany flavor. This specification discloses legume flavors treated to remove unwanted flavors, called in this specification de-flavored legume flours. Advantageously, the de-flavored legume flours are processed to have little damage, for example limited damage to starch or protein measured by percent enthalpy change relative to the native flour. As another advantage, the de-flavored legume flours disclosed in this specification also function like native flours or can be made to improve on certain functions of untreated legume flours. Also disclosed are the processes for making the de-flavored legume flours.

### BRIEF DESCRIPTION OF THE FIGURES

FIG. 1 graphs the flavor profile, as measured by a descriptive panel, of embodiments of de-flavored pea flours compared to an untreated pea flour.

FIG. 2 graphs the flavor profile, as measured by a descriptive panel, of embodiments of de-flavored fava bean flours compared to an untreated fava bean flour.

In one aspect the technology disclosed in this specification pertains to a de-flavored legume flour having improved flavor compared an untreated legume flour of the same base that further have useful water holding capacity and limited damage compared to the untreated flour. In any embodiment this specification discloses a de-flavored legume flour having a water holding capacity of at least about 1.4 (g/g), or at least about 2.0 or, at least about 2.15 or from about 2.15 to about 3.00 (g/g), or from about 2.15 to about 2.75, or to about 2.60, or to about 2.55, or to about 2.50. In any embodiment, this specification discloses a de-flavored legume flour having a percent starch damage of from 10% to about 50%, or from about 15% to about 50% from about 20% to about 50%, or about 20% to about 45%, or about 20% to about 40% or about 20% to about 35%, or about 25% to about 35%. In at least some embodiments, a de-flavored legume flour has a starch damage from about 20% to about 30%, or about 25% to about 30%, wherein the de-flavored legume flour is a de-flavored fava bean flour or a de-flavored pea flour having such damage. In some other embodiments, a de-flavored legume flour has a starch damage of less than about 20%, or less than about 15%, or from about 10% to about 20% or about 10% to about 15%, wherein the de-flavored legume flour is a de-flavored fava bean flour or a de-flavored pea flour having such damage. In any embodiment, this specification discloses a de-flavored legume flour having both the water holding capacity and the percent starch damage as described in this specification.

In some embodiments de-flavored legume flour described in this specification have protein content essentially equivalent to the protein content of the base legume. In other embodiments, a de-flavored legume flour described in this specification has less protein than the protein content of the base legume. Generally, embodiments of de-flavored legume flours have content less than about 30%, or less than about 25% or less than about 20%, or about 5% to about 10%, or about 15%, or about 20%, to about 30%. In some embodiments where the protein content of the de-flavored legume flour is like the protein content of the base legume, the protein content is from about 15% to about 30% or more preferably from about 20% to about 30%. In some embodiments where the protein content of the de-flavored legume flour is less than the protein content of the base protein, the protein content is from about 5% to about 15%, or more preferably from about 10% to about 15%. Legume compositions having protein content greater than the base legume material are not within the meaning of legume flour used in this specification. Accordingly legume flour, as used within this definition has protein content equal to or less than the protein content of the base legume.

In any embodiment described in this specification, a de-flavored legume flour has less bitter taste or less raw beany flavor or less overall flavor than an untreated legume flour of the same base material.

In any embodiment described in this specification, a de-flavored legume flour has a % reduction of at least 45% (measured using the GC/MS method provided in this specification) of at least one chemical present in an untreated pea protein concentrate wherein, optionally, chemical present in an untreated pea protein concentrated is at least one of acetaldehyde, ethanol, methyl-benzene, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-octen-3-ol, 1-heptanol, 1-octanol, (3e,5e)-3,5-octadien-2-one, 3-methyl-butanoic acid, 2-methyl-butanoic acid, hexanoic acid, 1-nonanol.

In any embodiment described in this specification, a de-flavored legume flour has a % reduction of at least 50% (measured using the GC/MS method provided in this specification) of at least one chemical present in an untreated pea protein concentrate wherein, optionally, chemical present in an untreated pea protein concentrated is at least one of acetaldehyde, ethanol, methyl-benzene, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-heptanol, 1-octanol, (3e,5e)-3,5-octadien-2-one, 3-methyl-butanoic acid, 2-methyl-butanoic acid, hexanoic acid, 1-nonanol.

In any embodiment described in this specification, a de-flavored legume flour has a % reduction of at least 60% (measured using the GC/MS method provided in this specification) of at least one chemical present in an untreated pea protein concentrate wherein, optionally, chemical present in an untreated pea protein concentrated is at least one of

In any embodiment described in this specification, a de-flavored legume flour has a % reduction of at least 70% (measured using the GC/MS method provided in this specification) of at least one chemical present in an untreated pea protein concentrate wherein, optionally, chemical present in an untreated pea protein concentrated is at least one of acetaldehyde, ethanol, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-heptanol, 1-octanol, (3e,5e)-3,5-octadien-2-one, hexanoic acid, 1-nonanol.

In any embodiment described in this specification, a de-flavored legume flour has a % reduction of at least 80% (measured using the GC/MS method provided in this specification) of at least one chemical present in an untreated pea protein concentrate wherein, optionally, chemical present in an untreated pea protein concentrated is at least one of acetaldehyde, ethanol, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, 2 octenal, 1-heptanol, (3e,5e)-3,5-octadien-2-one, hexanoic acid, 1-nonanol.

In any embodiment described in this specification, a de-flavored legume flour has a % reduction of at least 90% (measured using the GC/MS method provided in this specification) of at least one chemical present in an untreated pea protein concentrate wherein, optionally, chemical present in an untreated pea protein concentrated is at least one of acetaldehyde, hexanal, (z)-2-penten-1-ol, 2-pentyl-furan, ethenyl-benzene, octanal, cis 2 pentenol, (z)-non-2 enal, 6-methyl-5-hepten-2-one, 1-hexanol, 2 octenal, 1-heptanol, hexanoic acid, 1-nonanol.

In any embodiment described in this specification, a de-flavored legume flour has a % reduction of at least 95% (measured using the GC/MS method provided in this specification) of at least one chemical present in an untreated pea protein concentrate wherein, optionally, chemical present in an untreated pea protein concentrated is at least one of 2-pentyl-furan, octanal, cis 2 pentenol, 6-methyl-5-hepten-2-one, 1-hexanol, 2 octenal, 1-heptanol, hexanoic acid, 1-nonanol.

The de-flavored legume flours described in this specification may be made from any base legume. Preferred legumes useful for making a de-flavored legume flour, include pea, lentil, fava bean, and chickpea.

Water holding capacity is a useful attribute of flours particularly bakery applications where water holding capacity contributes to increased moisture, or increased bake spread, or reduced hardness. The de-flavored legume flours described in this specification have water holding capacity equal to or better than an untreated legume flour.

In some embodiments, a de-flavored legume flour is a pea flour. Untreated pea flours have generally low water holding capacity. Advantageously, the de-flavored pea flours described in this specification have higher water holding capacity than an untreated pea flour. In any embodiment described in this specification, a de-flavored pea flour has a percent increase of water holding capacity compared to the untreated pea flour of at least about 75%, or at least about 80%, or at least about 85%, or at least about 90%, or from about 75%, or about 80%, or about 85%, or about 90% to about 100%, or about 90% to about 95%.

In other embodiments a de-flavored legume flour is a lentil or fava bean flour. Untreated lentil and fava bean flours commonly have water holding capacity around 2 g/g. Accordingly, most embodiments of de-flavored legume flours have water holding capacity slightly improved water holding capacity. In some embodiments, this specification discloses a de-flavored legume flour having a percent change in water holding capacity compared to an untreated legume flour from the same base that is less than about 20%, or less than about 15%, or less than about 10%, or from about 5% to about 20%, or to about 15%, or to about 10%.

In still other embodiments, a de-flavored legume flour is a pea flour having starch damages (In some other embodiments, a de-flavored legume flour has a starch damage of less than about 20%, or less than about 15%, or from about 10% to about 20% or about 10% to about 15%) and has water holding capacity from about 1.4 to about 2.0 g/g or 1.4 to about 1.8, or a percent change in water holding capacity compared to an untreated pea flour from the same base that is less than about 20%, or less than about 15%, or less than about 10%, or from about 5% to about 20%, or to about 15%, or to about 10%.

The de-flavored legume flours are not enzymatically or chemically modified.

In another aspect the technology described in this specification pertains to a method for making a de-flavored legume flour. In any embodiment, a method for making a de-flavored legume flour comprises applying aqueous steam to the untreated legume flour in a ratio (flour to steam) of at least about 10:1 or at least about 11:1 or at least about 13.1, or at least at 15:1, or from about 10:1, or from about 11:1, or from about 13.1, or from at 15:1, or from about 17:1 to about 20:1; heating the steam and untreated legume flour at a temperature from about 150° C. to about 210° C., from about 160° C. to about 210° C., or from about 170° C. to about 210° C., or from about 175° C. to about 205° C. In at least some embodiments the steam and untreated legume flour are heated at a temperature from about 150° C. to about 205° C. or to about 195° C., or to about 185° C., or to about 175° C., or to about 165° C. In any embodiment described in this specification, a method for making a de-flavored flour includes applying liquid water or aqueous solution to the untreated legume flour in a ratio (flour to water) greater than about 4.4:1, or greater than about 5:1, or from about 4.4:1, or from 5:1, or from about 6:1 to about 9:1. In some embodiments described in this specification, a method for making a de-flavored flour comprises applying both aqueous steam and one of liquid water or aqueous solution to an untreated legume flour in ratios described in this paragraph. In any embodiment of the method for making a de-flavored legume flour described in this specification, heating step is for a time from about 1 to 2 minutes.

Reference to an untreated legume flour in this specification refers to powdered legume material of any particle size suitable for use in the chosen de-flavoring reactors. For example, untreated legume flour includes compositions having particle sizes that may more commonly be though of as legume meal or grits, etc. Legume flour can be obtained by any suitable method such as grinding or milling, including wet milling, dry milling. Legume flour can have protein content substantially the same as base legume or can have reduced protein content than the base legume. Untreated legume flour is that the flour is not treated with chemical or enzyme whether to crosslink or hydrolyze, or deamidate or ferment the flour. For untreated legume flours having lower protein than the base legume, the protein content is reduced in a way that minimizes damage to the starch and the protein such that the starch and remaining protein are substantially as they would be found in an untreated legume flour having protein content essentially the same as the base pulse.

Application of one or more of aqueous steam, and liquid water or aqueous solution as described in this reaction increases moisture content of the untreated legume flour above its ambient moisture content, commonly from about 8% to about 12% (wt. % moisture content). The additions of one or more of aqueous steam, and liquid water or aqueous solution increases is not intended to create a slurry, meaning that preferably, for any embodiment disclosed in this specification, the flour is able to absorb all liquid added to the system so that remains a single-phase systems (i.e. there is only a flour phase; there is no free liquid phase). Generally, flour can have a moisture content of from about 50% to about 60% (wt. % moisture) before a liquid phase forms.

De-flavored legume flours described in this specification can be made in one or more reactors useful for applying one or more of aqueous steam, liquid water or aqueous solution to form a mixture and heating the mixture. A useful reactor is a fluidizing bed reactor, an illustrative embodiment of which is described in U.S. Pat. No. 5,378,434. Fluidized bed reactors generally comprise a hollow reactor vessel with one or more ports, at least some being at the bottom of the vessel, through which air or other gas is pumped to disperse (fluidize) a powder placed within the chamber of the reactor. Among the gases that can be injected into a fluidizing bed reactor is steam. Flours can be moistened by injection of steam alone (being loaded into the reactor at ambient moisture) or can be pre-moistened prior to being loaded into the reactor. With reference to the methods for de-flavoring legume flour described in this specification, air flow and steam flow in the reactor apply moisture to untreated legume flour. The reactor wall can be heated, and heated gas can be used to heat the moistened legume flours as described in this specification. Also, the moisture content of the gas in the fluidizing bed reactor can be adjusted to dry the de-flavored legume flour.

Another useful reactor is a hollow tube reactor. Various hollow-tube type reactors are available on the market and are useful for carrying out the methods for de-flavoring legume flour described in this specification include but are not limited to CoriMix® reactors (Lodige Process Technologies) and Horizontal Plow Mixers (B&P Littleford), and other reactors of this type. Generally, a hollow-tube reactor comprises hollow-tube through which material may pass, inlet ports or other means introducing solid materials like untreated legume flour and a fluids, like air or aqueous steam or liquid water or aqueous solution, into the hollow tube of the reactor so that the fluid is applied to the material passing through the reactor. Hollow-tube reactors also comprise a rotor, which is commonly screw shaped or comprises a radially projecting elements (like a fan). In operation the rotor pushes the material forward to an outlet port and may press material against the inner wall of the hollow tube as the material is pushed from an inlet port to an outlet port. In the methods for de-flavoring legume flour described in this specification the inner wall of the hollow tube is heated to the temperatures described in order to heat the moistened legume flour as it is pushed through the length of the hollow tube.

In any embodiment described in this specification, a method for making a de-flavored legume flour further comprises drying the de-flavored legume flour to a moisture content from about 4% to about 15% (wt. %) with an air flow having a temperature from about 140° C. to about 160° C., or from about 145° C. to about 155° C.

In preferred embodiments de-flavored legume flours are made in one or more hollow-tube reactors. In such embodiments, the hollow-tube reactor comprises a rotor within the hollow tube of the hollow-tube reactor. In such embodiments one or more of steam and liquid water or aqueous solution are applied to untreated legume flour to form a moistened legume flour that is heated in the hollow tube of a hollow tube reactor, and the the rotor is rotated at a rate less than about 700 or less than about 600 RPM or less than about 500 RPM or less than about 450 RPM, or from about 300 RPM to about 600, or from about 350 RPM to about 550, or to about 500, or about 450. Note that while the process is described as applying step and a heat step, the step can occur essentially simultaneously as untreated legume flour can be fed into a heated hollow-tube reactor at the same time as the one or of aqueous steam, and liquid water or aqueous solutions are applied to the untreated legume flour.

In some embodiments described in this specification, a de-flavored legume flour is dried in a hollow tube of a hollow-tube reactor that reactor further comprises a rotor within the hollow tube of the hollow-tube reactor. In such embodiments the rotor is rotated at a rate of from about 300, to about 700, or to about 600, or to about 500 RPM or in some preferred embodiments from about 350 to about 450 RPM.

In at least some embodiments described in this specification, a methods for making a de-flavored legume flour described is a follows. The de-flavored legume flour is dried to a moisture content from about 4% to about 15% (wt. %) in a hollow tube of a hollow-tube reactor, the reactor further comprising a rotor within the hollow tube of the hollow-tube reactor in a hollow tube reactor. The drying is done at least in part by passing air having a temperature from about 140° C. to about 160° C., or from about 145° C. to about 155° C. through the hollow tube of the reactor. Also, the rotor within the hollow-tube reactor is rotated at a rate of from about 300 to about 500 RPM or from about 350 to about 450 RPM.

In at least some embodiments of the methods described in this specification, one or more of aqueous steam, and liquid water or aqueous solution are applied to the untreated legume flour to form a moistened legume flour that is heated in a first hollow-tube reactor to form a de-flavored legume flour that is dried in a second hollow-tube reactor.

In embodiment where the untreated legume flour has less protein than the base legume the untreated legume flour may be called a low protein legume flour. This is done for clarity and unless said otherwise, untreated low protein legume flour is within the meaning of untreated legume flour. In any embodiment low protein is obtained by separating part of the protein from the untreated flour. It is not intended that the processes are applied to starch as such low protein legume flours have protein content of at least about 1%, more preferably at least about 5% protein (wt. %). In preferred embodiments, low protein legume flours have protein content of 5% to about 15% (wt. %), or more preferably from about 10% to about 15%. Preferably, processes used to separate part of the protein from the untreated legume flour using a process that does not denature the protein in the flour or damage the starch.

A useful method separating components of an untreated legume flour to obtain a low protein flour is air classification. Air classification uses air currents and a countervailing force to separate parts of a pea flour. For example, an air classifier may use air currents and a rotating mechanism to generate a centripetal fore on the flour. In operation, starch and protein generally have different weight and size and so experience drag and centripetal differently force. These differences can be used separate the protein from other parts of the flour. Air classifiers are known and available for example from Hosokawa-Alpine. An air classification process obtains a high protein, low starch portion called in this specification the base pea protein concentrate, which can be used for other purposes and low protein, high starch portion which, for this specification is within the meaning of legume flour The high protein, low starch component is not within the definition of legume flour in this specification, whether the legume flour is called untreated, moistened, or de-flavored because it has protein content greater than the base legume.

The de-flavored legume flours described are used as other flour and other legume flours are used. In any embodiment described in this specification, a de-flavored legume flour as is used food composition. The legume flours useful in food compositions in an amount from 1% to 99% wt. % of the food composition. The disclosed legume flours are useful to replace can be used to replace animal protein or replace gluten containing flours or to provide fortification relative cereal flours. Illustrative food compositions include gravies, sauces, particularly vegan white sauces or cheese sauces, soups, puddings, salad dressings, analog yogurts, analog sour creams, custards, analog cheese products, baked goods including pastries and dough based baked goods like pie crusts, cookies, breads, crackers, or batter based baked goods like cakes, and muffins.

In at least some embodiments a de-flavored legume flour, as described in this specification, is used in a baked good to reduce the usage of a cereal flour in whole or in part. In at least some embodiments of the de-flavored legume flour is used in a gluten free baked good.

In at least some embodiments this specification discloses a food composition that is a baked good comprising the de-flavored legume flour. In some embodiments this specification discloses a food composition comprising a de-flavored legume flour and wheat flour used in a ratio (de-flavored legume flour to wheat flour) of from about 1:1 to about 1:5, or from about 1:2 to about 1:5, or from 1:3, to 1:5. In at least some embodiments this specification discloses a food composition, being a baked good having a flour component that consists of all of the flour within the baked good, and wherein the flour component comprises de-flavored legume flour in an amount of at least about 10%, or at least about 20%, or at least about 30%, or at least about 40%, or at least about 50%. In other embodiments, this specification disclose a baked good comprising a flour component that consists of all of the flour within the bake good, and wherein the flour component consists of de-flavored legume flour and wheat flour and wherein the de-flavored legume flour is used in the flour component in an amount from about 10% to about 50%, or to about 40%, or to about 30%, or to about 25% (wt. %), or from about 15% to about 50%, or to about 40%, or to about 30%, or to about 25% (wt. %).

The de-flavored legume flours have been observed, advantageously, to reduce the hardness of a baked good relative to the same baked good using an untreated legume flour. The de-flavored legume flours have been observed, advantageously, to reduce the spread of a baked good relative to the same baked good using an untreated legume flour.

In any embodiment this specification describes methods for making baked goods comprises adding a de-flavored legume flour and a second ingredient. With reference to compositions that are edible ingredients, second ingredients can be any edible ingredient, including but not limited to aqueous or lipid-based ingredients, fats, oils, other starches (including native, gelatinized, and modified starches), flour, hydrocolloids or gelling agents, flavorings, coloring, sweeteners, and dairy ingredients.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting aspects, which are provided for illustrative purposes and are not intended to limit the full scope of the invention.

1. A de-flavored legume flour having a water holding capacity of at least about 1.4 (g/g), or at least about 2.0 or, at least about 2.15 or from about 2.15 to about 3.00 (g/g), or from about 2.15 to about 2.75, or to about 2.60, or to about 2.55, or to about 2.50.

2. A de-flavored legume flour having from 10% to about 50%, or from about 15% to about 50% from about 20% to about 50%, or about 20% to about 45%, or about 20% to about 40% or about 20% to about 35%, or about 25% to about 35% optionally wherein the starch damage is in a range selected from the group consisting of: a about 20% to about 30%, or about 25% to about 30%, wherein, preferably, the de-flavored legume flour is a de-flavored fava bean flour or a de-flavored pea flour having such damage; and b. less than about 20%, or less than about 15%, or from about 10% to about 20% or about 10% to about 15%, wherein preferably, the de-flavored legume flour is a de-flavored fava bean flour or a de-flavored pea flour having such damage.

3. The de-flavored legume flour as described in claims 1 and 2

4. The de-flavored legume flour of any one of claims 1 to 3 having protein content essentially equivalent to the protein content of the base legume or less than the base legume.

5. The de-flavored legume flour of any one of claims 1 to 4 having protein content less than about 30%, or less than about 25% or less than about 20%, or about 5% to about 10%, or about 15%, or about 20%, to about 30% or in a range selected from the group consisting of: a. from about 5% to about 15%, or more preferably from about 10% to about 15%; and b. from about 15% to about 30% or more preferably from about 20% to about 30%; wherein, optionally, the de-flavored legume flour having protein content essentially equivalent to the protein content of the base legume.

6. The de-flavored legume flour of any one of claims 1 to 5 having protein content less than the protein content of the base legume wherein, optionally, from about 5% to about 15%, or more preferably from about 10% to about 15%.

7. The de-flavored legume flour of any one of claims 1 to 6 having less bitter or raw beany flavor or overall flavor than an untreated legume flour of the same base material.

8. The de-flavored legume flour of claims 1 to 7 being selected from the group consisting of pea, lentil, fava bean, and chickpea.

9. The de-flavored legume flour of claims 1 to 8 being a pea flour having a higher water holding capacity than an untreated pea flour, optionally, wherein the de-flavored pea flour has a percent increase of water holding capacity compared to the untreated pea flour of at least about 75%, or at least about 80%, or at least about 85%, or at least about 90%, or from about 75%, or about 80%, or about 85%, or about 90% to about 100%, or about 90% to about 95%.

10. The de-flavored legume flour of claims 1 to 9 having a percent change in water holding capacity compared to an untreated legume flour from the same base that is less than about 20%, or less than about 15%, or less than about 10%, or from about 5% to about 20%, or to about 15%, or to about 10%; optionally, wherein the de-flavored legume flour is a fava bean flour or lentil flour.

11. The de-flavored legume flour of any one of claims 1 to 10 being a de-flavored pea flour and having a. a percent change starch damage compare an untreated pea flour of less than about 20%, or less than about 15%, or from about 10% to about 20% or about 10% to about 15% and b. or more of (i) a water holding capacity from about 1.4 to about 2.0 g/g or 1.4 to about 1.8, and (ii) a percent change in water holding capacity compared to an untreated pea flour from the same base that is less than about 20%, or less than about 15%, or less than about 10%, or from about 5% to about 20%, or to about 15%, or to about 10%.

12. The de-flavored legume flour of any one of claims 1 to 11 being a fava bean flour having a starch damage from about 20% to about 30%, or about 25% to about 30%.

13. The de-flavored legume flour of claims 1 to 12 that is not enzymatically or chemically modified.

14. A method for making a de-flavored legume flour comprising: a. applying aqueous steam to the untreated legume flour in a ratio (flour to steam) of at least about 10:1 or at least about 11:1 or at least about 13.1, or at least at 15:1, or from about 10:1, or from about 11:1, or from about 13.1, or from at 15:1, or from about 17:1 to about 20:1 to obtain a moistened legume flour; b heating the moistened legume flour at a temperature from a range selected from the group consisting of: i. from about 150° C. to about 210° C., from about 160° C. to about 210° C., or from about 170° C. to about 210° C., or from about 175° C. to about 205° C.; ii. from about 150° C. to about 205° C. or to about 195° C., or to about 185° C., or to about 175° C., or to about 165° C. 170° C. to about 210° C., or from about 180° C. to about 200° C.; and iii. from about from about 175° C. to about 205° C., or about 175° C. to about 195° C. or about 175° C. to about 185° C.

15. The method of claim 14 wherein the applying and heating steps take place in a hollow tube reactor or a fluidized bed reactor.

16. The method of claim 14 of 15 wherein the heating is for a time from about 1 to 2 minutes to obtain a de-flavored legume flour.

17. The method of any one claims 14 to 16 further comprising drying the de-flavored legume flour to a moisture content from about 4% to about 15% (wt. %) with an air flow having a temperature from about 140° C. to about 160° C., or from about 145° C. to about 155° C.

18. The method of any one of claims 14 to 17 further comprising, applying liquid water or aqueous solution to the untreated legume flour in a ratio (flour to water) greater than about 4.4:1, or greater than about 5:1, or from about 4.4:1, or from 5:1, or from about 6:1 to about 9:1.

19. The method of any one of claims 14 to 18 the applying step comprises applying: a. an aqueous steam to an untreated legume flour in a ratio (flour to steam) of at least about 10:1 or at least about 11:1 or at least about 13.1, or at least at 15:1, or from about 10:1, or from about 11:1, or from about 13.1, or from at 15:1, or from about 17:1 to about 20:1; and b. liquid water or aqueous solution to the untreated legume flour in a ratio (flour to water) greater than about 4.4:1, or greater than about 5:1, or from about 4.4:1, or from 5:1, or from about 6:1 to about 9:1.

20. The method of any one of claims 14 to 19 wherein the applying step and heating step occur in a hollow tube of a hollow tube reactor, the reactor further comprising a rotor within the hollow tube of the hollow-tube reactor; and wherein the rotor is rotated at a rate less than about 700 or less than about 600 RPM or less than about 500 RPM or less than about 450 RPM, or from about 300 RPM to about 600, or from about 350 RPM to about 550, or to about 500, or about 450.

21. The method of any one of claims 14 to 20 further comprising drying the de-flavored legume flour in a hollow tube of a hollow-tube reactor, the reactor further comprising a rotor within the hollow tube of the hollow-tube reactor; and wherein the rotor is rotated at a rate of from about 300 to about 700 or to about 600 or to about 500 RPM or from about 350 to about 450 RPM.

22. The method of claims 14 to 21 further comprising drying the de-flavored legume flour to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 700, or to about 600, or to about 500 RPM, or from about 350 to about 450 RPM.

23. The method of any one of claims 14 to 22 wherein the applying step and heating step are done in a first hollow-tube reactor and the de-flavored legume flour is dried in a second hollow-tube reactor.

24. The method of any one of claims 14 to 23 wherein the untreated legume flour is a low protein legume flour from about 5% to about 15%, or more preferably from about 10% to about 15%.

25. The method of any one of claims 14 to 24 further comprising, prior to step a) separating of the protein from the untreated legume flour.

26. The method of any one of claims 14 to 25 further comprising, prior to step a) separating part of the protein from the untreated legume flour using a process that does not denature the protein in the flour or damage the starch.

27. The method of any one of claims 14 to 26 further comprising, prior to step a) separating part of the protein from the untreated legume flour using an air classification process

28. The method of any one of claims 14 to 27 wherein the liquid water or aqueous solution or aqueous steam do not comprise an enzyme or chemical that that enzymatically or chemically modifies the de-flavored legume flour.

29. The method of any one of claims 14 to 28 wherein the untreated legume flour is selected from the group consisting of pea, lentil, fava bean, and chickpea.

30. A de-flavored legume flour as described in any one of claims 1 to 13 made by a process a process a described in any one claims 14 to 29.

31. Use of a de-flavored legume flour as described in any foregoing claim a food composition.

32. Use of de-flavored legume flour as described in claim 31 to replace at least part of a cereal flour in a baked good, optionally, wherein the de-flavored legume flour replaces the cereal flour on a one-for-one basis (w/w).

33. Use of a de-flavored legume flour as described in claim 31 or 32 in a gluten free baked good.

34. A food composition comprising a de-flavored legume flour as described in any foregoing claim and an edible ingredient.

35. The food composition of claim 34 wherein the composition is a food composition, or a gluten free food composition.

36. The food composition of claim 34 or 35 further comprising a wheat flour used in a ratio (de-flavored legume flour to wheat flour) of from about 1:1 to about 1:5, or from about 1:2 to about 1:5, or from 1:3, to 1:5

37. The food composition of any one of claims 34 to 36 being a baked good, which has a flour component that consists of all the flour within the baked good, and wherein the flour component comprises de-flavored legume flour in an amount of at least about 10%, or at least about 20%, or at least about 30%, or at least about 40%, or at least about 50%.

38. The food composition of any one of claims 34 to 37 being a baked good comprising a flour component that consists of all of the flour within the bake good, and wherein the flour component consists of de-flavored legume flour and wheat flour and wherein the de-flavored legume flour is used in the flour component in an amount from about 10% to about 50%, or to about 40%, or to about 30%, or to about 25% (wt. %), or from about 15% to about 50%, or to about 40%, or to about 30%, or to about 25% (wt. %).

39. The food composition of any one of claims 34 to 38 being a gluten free. The technology described in this specification can be further understood with reference to the following non-limiting examples, which are provided for illustrative purposes and are not intended to limit the full scope of the invention.

40 A de-flavored legume flour comprising: a starch and a protein, wherein de-flavored legume flour has a water holding capacity of at least about 1.4 (g/g), or at least about 2.0 or, at least about 2.15 or from about 2.15 to about 3.00 (g/g), or from about 2.15 to about 2.75, or from 2.15 to about 2.60, or to about 2.55, or to about 2.50 wherein the protein content less than about 30%, or less than about 25% or less than about 20%.

41. A de-flavored legume flour: comprising a starch and a protein, wherein the de-flavored legume flour has a starch damage from 10% to about 50%, or from about 15% to about 50% from about 20% to about 50%, or from about 20% to about 45%, or from about 20% to about 40% or from about 20% to about 35%, or from about 25% to about 35% wherein the protein is in an amount no more than essentially equivalent to the protein content of the base legume, or in an amount essentially equivalent to the protein content of the base legume optionally wherein the starch damage is in a range selected from the group consisting of: a. about 20% to about 30%, or about 25% to about 30%, wherein, preferably, the de-flavored legume flour is a de-flavored fava bean flour or a de-flavored pea flour having such damage; and b. less than about 20%, or less than about 15%, or from about 10% to about 20% or about 10% to about 15%, wherein preferably, the de-flavored legume flour is a de-flavored fava bean flour or a de-flavored pea flour having such damage.

42. The de-flavored legume flour as described in claims 40 and 41

43. The de-flavored legume flour of any one of claims 40 to 42 less than the protein content of the base legume; wherein, optionally, protein content is in an amount from about 5% to about 15%, or more preferably from about 10% to about 15%.

44. The de-flavored legume flour of any one of claims 40 to 43 having protein essentially equal to the protein content of the base legume, wherein optionally: from about 15% to about 30% or more preferably from about 20% to about 30%.

45. The de-flavored legume flour of any one of claims 40 to 44 having less bitter or raw beany flavor or overall flavor than an untreated legume flour of the same base material.

46. The de-flavored legume flour of claims 40 to 45 being selected from the group consisting of pea, lentil, fava bean, and chickpea.

47. The de-flavored legume flour of claims 40 to 46 being a pea flour having a higher water holding capacity than an untreated pea flour, optionally, wherein the de-flavored pea flour has a percent increase of water holding capacity compared to the untreated pea flour of at least about 75%, or at least about 80%, or at least about 85%, or at least about 90%, or from about 75%, or about 80%, or about 85%, or about 90% to about 100%, or about 90% to about 95%.

48. The de-flavored legume flour of claims 40 to 47 having a percent change in water holding capacity compared to an untreated legume flour from the same base that is less than about 20%, or less than about 15%, or less than about 10%, or from about 5% to about 20%, or to about 15%, or to about 10%; optionally, wherein the de-flavored legume flour is a fava bean flour or lentil flour.

49. The de-flavored legume flour of any one of claims 40 to 48 being a de-flavored pea flour and having a) a percent change starch damage compares an untreated pea flour of less than about 20%, or less than about 15%, or from about 10% to about 20% or about 10% to about 15% and b) or more of (i) a water holding capacity from about 1.4 to about 2.0 g/g or 1.4 to about 1.8, and (ii) a percent change in water holding capacity compared to an untreated pea flour from the same base that is less than about 20%, or less than about 15%, or less than about 10%, or from about 5% to about 20%, or to about 15%, or to about 10%.

50. The de-flavored legume flour of any one of claims 40 to 49 being a fava bean flour having a starch damage from about 20% to about 30%, or about 25% to about 30%.

51. The de-flavored legume flour of claims 40 to 50 that is not enzymatically or chemically modified.

52. The de-flavored legume flour of an one of claims 40 to 51 a having a % reduction of at least 45% (measured using the GC/MS method provided in this specification) of at least one chemical present in an untreated pea protein concentrate wherein, optionally, chemical present in an untreated pea protein concentrated is at least one of acetaldehyde, ethanol, methyl-benzene, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-octen-3-ol, 1-heptanol, 1-octanol, (3e,5e)-3,5-octadien-2-one, 3-methyl-butanoic acid, 2-methyl-butanoic acid, hexanoic acid, 1-nonanol.

53. The de-flavored legume flour (or fava bean flour or pea flour of any one of claims 40 to 52 having a % reduction of at least 50% (measured using the GC/MS method provided in this specification) of at least one chemical present in an untreated pea protein concentrate wherein, optionally, chemical present in an untreated pea protein concentrated is at least one of acetaldehyde, ethanol, methyl-benzene, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-heptanol, 1-octanol, (3e,5e)-3,5-octadien-2-one, 3-methyl-butanoic acid, 2-methyl-butanoic acid, hexanoic acid, 1-nonanol.

54. The de-flavored legume flour (or fava bean flour or pea flour of any one of claims 40 to 53 having a % reduction of at least 60% (measured using the GC/MS method provided in this specification) of at least one chemical present in an untreated pea protein concentrate wherein, optionally, chemical present in an untreated pea protein concentrated is at least one of

55. The de-flavored legume flour (or fava bean flour or pea flour of any one of claims 40 to 54 having a % reduction of at least 70% (measured using the GC/MS method provided in this specification) of at least one chemical present in an untreated pea protein concentrate wherein, optionally, chemical present in an untreated pea protein concentrated is at least one of acetaldehyde, ethanol, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-heptanol, 1-octanol, (3e,5e)-3,5-octadien-2-one, hexanoic acid, 1-nonanol.

56. The de-flavored legume flour (or fava bean flour or pea flour of any one of claims 40 to 55 having a % reduction of at least 80% (measured using the GC/MS method provided in this specification) of at least one chemical present in an untreated pea protein concentrate wherein, optionally, chemical present in an untreated pea protein concentrated is at least one of acetaldehyde, ethanol, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, 2 octenal, 1-heptanol, (3e,5e)-3,5-octadien-2-one, hexanoic acid, 1-nonanol.

57. The de-flavored legume flour (or fava bean flour or pea flour of any one of claims 40 to 56 having a % reduction of at least 90% (measured using the GC/MS method provided in this specification) of at least one chemical present in an untreated pea protein concentrate wherein, optionally, chemical present in an untreated pea protein concentrated is at least one of acetaldehyde, hexanal, (z)-2-penten-1-ol, 2-pentyl-furan, ethenyl-benzene, octanal, cis 2 pentenol, (z)-non-2 enal, 6-methyl-5-hepten-2-one, 1-hexanol, 2 octenal, 1-heptanol, hexanoic acid, 1-nonanol.

58. The de-flavored legume flour (or fava bean flour or pea flour of any one of claims 40 to 57 having a % reduction of at least 95% (measured using the GC/MS method provided in this specification) of at least one chemical present in an untreated pea protein concentrate wherein, optionally, chemical present in an untreated pea protein concentrated is at least one of 2-pentyl-furan, octanal, cis 2 pentenol, 6-methyl-5-hepten-2-one, 1-hexanol, 2 octenal, 1-heptanol, hexanoic acid, 1-nonanol.

59. A method for making a de-flavored legume flour comprising: a) applying aqueous steam to the untreated legume flour in a ratio (flour to steam) of at least about 10:1 or at least about 11:1 or at least about 13.1, or at least at 15:1, or from about 10:1, or from about 11:1, or from about 13.1, or from at 15:1, or from about 17:1 to about 20:1 to obtain a moistened legume flour; b) heating the moistened legume flour at a temperature from a range selected from the group consisting of: i) from about 150° C. to about 210° C., from about 160° C. to about 210° C., or from about 170° C. to about 210° C., or from about 175° C. to about 205° C.; and ii) from about 150° C. to about 205° C. or to about 195° C., or to about 185° C., or to about 175° C., or to about 165° C. 170° C. to about 210° C., or from about 180° C. to about 200° C.; and iii) from about from about 175° C. to about 205° C., or about 175° C. to about 195° C. or about 175° C. to about 185° C.

60. The method of claim 59 wherein the heating is for a time from about 1 to 2 minutes to obtain a de-flavored legume flour.

61. The method of claim 59 or 60 further comprising drying the de-flavored legume flour to a moisture content from about 4% to about 15% (wt. %) with an air flow having a temperature from about 140° C. to about 160° C., or from about 145° C. to about 155° C.

62. The method of any one of claims 59 to 61 further comprising, applying liquid water or aqueous solution to the untreated legume flour in a ratio (flour to water) greater than about 4.4:1, or greater than about 5:1, or from about 4.4:1, or from 5:1, or from about 6:1 to about 9:1.

63. The method of any one of claims 59 to 62 the applying step comprises applying: a) an aqueous steam to an untreated legume flour in a ratio (flour to steam) of at least about 10:1 or at least about 11:1 or at least about 13.1, or at least at 15:1, or from about 10:1, or from about 11:1, or from about 13.1, or from at 15:1, or from about 17:1 to about 20:1; and b) liquid water or aqueous solution to the untreated legume flour in a ratio (flour to water) greater than about 4.4:1, or greater than about 5:1, or from about 4.4:1, or from 5:1, or from about 6:1 to about 9:1.

64. The method of any one of claims 59 to 63 wherein the applying step and heating step occurs in a hollow tube of a hollow tube reactor, the reactor further comprising a rotor within the hollow tube of the hollow-tube reactor; and wherein the rotor is rotated at a rate less than about 700 or less than about 600 RPM or less than about 500 RPM or less than about 450 RPM, or from about 300 RPM to about 600, or from about 350 RPM to about 550, or to about 500, or about 450.

65. The method of any one of claims 59 to 64 further comprising drying the de-flavored legume flour in a hollow tube of a hollow-tube reactor, the reactor further comprising a rotor within the hollow tube of the hollow-tube reactor; and wherein the rotor is rotated at a rate of from about 300 to about 700 or to about 600 or to about 500 RPM or from about 350 to about 450 RPM.

66. The method of any one of claims 59 to 65 further comprising drying the de-flavored legume flour to a moisture content from about 4% to about 15% (wt. %) in a hollow tube of a hollow-tube reactor, the reactor further comprising a rotor within the hollow tube of the hollow-tube reactor: wherein the drying is done at least in part by passing air having a temperature from about 140° C. to about 160° C., or from about 145° C. to about 155° C. through the hollow tuber of the reactor; and wherein the rotor is rotated at a rate of from about 300 to about 700, or to about 600, or to about 500 RPM, or from about 350 to about 450 RPM.

67. The method of any one of claims 59 to 66 wherein the applying step and heating step are done in a first hollow-tube reactor and the de-flavored legume flour is dried in a second hollow-tube reactor.

68. The method of any one of claims 59 to 67 wherein the untreated legume flour is a low protein legume flour from about 5% to about 15%, or more preferably from about 10% to about 15%.

69. The method of any one of claims 59 to 68 further comprising, prior to step a) separating part of the protein from the untreated legume flour.

70. The method of any one of claims 59 to 69 further comprising, prior to step a) separating part of the protein from the untreated legume flour using a process that does not denature the protein in the flour or damage the starch, wherein, optionally, the separating part of the protein from the untreated legume flour uses an air classification process.

71. A de-flavored legume flour as described in any one of claims 40 to 58 made by a process a process a described in anyone claims 59 to 69.

73. Use of a de-flavored legume flour as described in any foregoing claim a food composition.

74. Use of de-flavored legume flour as described in claim 73 to replace at least part of a cereal flour in a baked good, optionally, wherein the de-flavored legume flour replaces the cereal flour on a one-for-one basis (w/w).

75. Use of a de-flavored legume flour as described in claim 73 or 74 in a gluten free baked good.

76. A food composition comprising a de-flavored legume flour as described in any foregoing claim and an edible ingredient.

77. The food composition of claim 76 wherein the composition is a food composition, or a gluten free food composition.

78. The food composition of claim 76 or 77 further comprising a wheat flour used in a ratio (de-flavored legume flour to wheat flour) of from about 1:1 to about 1:5, or from about 1:2 to about 1:5, or from 1:3, to 1:5

79. The food composition of any one of claims 76 to 78 being a baked good, which has a flour component that consists of all the flour within the baked good, and wherein the flour component comprises de-flavored legume flour in an amount of at least about 10%, or at least about 20%, or at least about 30%, or at least about 40%, or at least about 50%.

80. The food composition of any one of claims 76 to 79 being a baked good comprising a flour component that consists of all of the flour within the bake good, and wherein the flour component consists of de-flavored legume flour and wheat flour and wherein the de-flavored legume flour is used in the flour component in an amount from about 10% to about 50%, or to about 40%, or to about 30%, or to about 25% (wt. %), or from about 15% to about 50%, or to about 40%, or to about 30%, or to about 25% (wt. %).

81. The food composition of any one of claims 76 to 80 being a gluten free.

### EXAMPLE 1—PROCESSES FOR MAKING DE-FLAVORED LEGUME FLOUR

De-flavored legume flours were made using a two-stage hollow-tube reactor comprising thermal cooking reactor and drying reactor. Both stages of the reactor were jacketed hollow-tube reactors with inlets for receiving a liquid or a gas. The jacket heated the inner surface of the hollow-tube reactor. During processing raw legume flour (moisture content about 10%) was fed into the cooking reactor along with steam and water (from separate inlets) to form a high moisture flour. The flour passed through the reactor and was then dried in the drying reactor, which dried the legume flour using heat and warmed air.

De-flavored legume flours were made from pea flour base, lentil flour base, and fava bean flour base. The base material was obtained by milling split pea or fava bean to obtain the corresponding flour. Various processing conditions used to make de-flavored pea flours are reported in Table 1. The process variables described were applied in the cooking reactor. For all batches water temperature was 80° C. All legume flours used were full protein, having protein content essentially the same as the base legume.

TABLE 1
Cook Reactor Process Conditions For De-Flavored Pea Flour

| | | Cooking | Cooking | | | | |
|---|---|---|---|---|---|---|---|
| | Feed | reactor | reactor | Water | Feed Rate | Steam | Steam rate |
| | Rate | temperature | speed | Rate | to Water | Rate | to feed rate |
| Batch | (kg/hr) | (wall) (° C.) | (RPM) | (L/hr) | Rate Ratio | (L/hr) | ratio |
| P1015 | 3300 | 180 | 400 | 800 | 4.1:1 | 300 | 11:1 |
| P1120 | 4000 | 180 | 400 | 800 | 5:1 | 300 | 13.3:1 |
| P1220 | 5400 | 180 | 500 | 600 | 9:1 | 300 | 18:1 |
| P1320 | 3300 | 180 | 500 | 800 | 4.1:1 | 300 | 11:1 |
| P1250 | 5400 | 180 | 500 | 900 | 6:1 | 300 | 18:1 |
| P1130 | 4000 | 180 | 500 | 900 | 4.4:1 | 300 | 13.3:1 |

De-flavored fava bean flours were made using various process conditions reported in Table 2. The process variables described were applied in the cooking reactor. For all batches water temperature was 80° C.

TABLE 2
Cook Reactor Process Conditions For De-Flavored Fava Bean Flour

| | | Cooking | Cooking | | | | |
|---|---|---|---|---|---|---|---|
| | Feed | reactor | reactor | Water | Feed Rate | Steam | Feed rate to |
| | Rate | temperature | speed | Rate | to Water | Rate | steam rate |
| Batch | (kg/hr) | (wall) (° C.) | (RPM) | (L/hr) | Rate Ratio | (L/hr) | ratio |
| F1215 | 5400 | 180 | 400 | 600 | 9:1 | 300 | 18:1 |
| F1300 | 5400 | 180 | 500 | 600 | 9:1 | 300 | 18:1 |
| F1400 | 5400 | 180 | 500 | 900 | 6:1 | 300 | 18:1 |
| F1000 | 5400 | 200 | 500 | 900 | 6:1 | 300 | 18:1 |
| F1100 | 5400 | 200 | 500 | 600 | 9:1 | 300 | 18:1 |
| F1200 | 5400 | 200 | 400 | 600 | 9:1 | 300 | 18:1 |
| F1145 | 5400 | 200 | 400 | 900 | 6:1 | 300 | 18:1 |

De-flavored lentil flours were made using various process conditions reported in Table 3. The process variables described were applied in the cooking reactor. For all batches water temperature was 80° C.

TABLE 3
Cook Reactor Process Conditions For De-Flavored Lentil Flour

| | | Cooking | Cooking | | | | |
|---|---|---|---|---|---|---|---|
| | Feed | reactor | reactor | Water | Feed Rate | Steam | Feed rate to |
| | Rate | temperature | speed | Rate | to Water | Rate | steam rate |
| Batch | (kg/hr) | (wall) (° C.) | (RPM) | (L/hr) | Rate Ratio | (L/hr) | ratio |
| L0930 | 5400 | 180 | 400 | 600 | 9:1 | 300 | 18:1 |
| L1345 | 5400 | 200 | 500 | 900 | 6:1 | 300 | 18:1 |

All samples of de-flavored pea flour and de-flavored fava bean flour were dried in the drying reactor under the same conditions, which are listed in Table 4.

TABLE 4
Drying Reactor Process Conditions

| Dryer | | Air | |
|---|---|---|---|
| speed | Dryer Oil Inlet | Temperature | Air Fan |
| (RPM) | Temperature (° C.) | (° C.) | Speed (%) |
| 400 | 180 | 150 | 60 |

### EXAMPLE 2—SENSORY EVALUATION OF PULSE FLOUR

For De-flavored legume flours samples were blended with spring water to create 6.6% solutions, accounting moisture. All samples were evaluated by a highly trained descriptive panel for 7 flavor and texture attributes. Samples were prepared on the day of evaluation and assessed at ambient temperature (˜70° F.). Intensities were rated using a 15-point Universal Scale. Analysis of Variance (ANOVA) and Tukey's post-hoc multiple comparison test was applied to the data to assess statistical significance. (See e.g. Meilgaard, M. C. et al., Sensory Evaluation Techniques, Fourth Edition, CRC Press (2007) (ISBN: 0-8493-3839-5) at pp. 189-254)

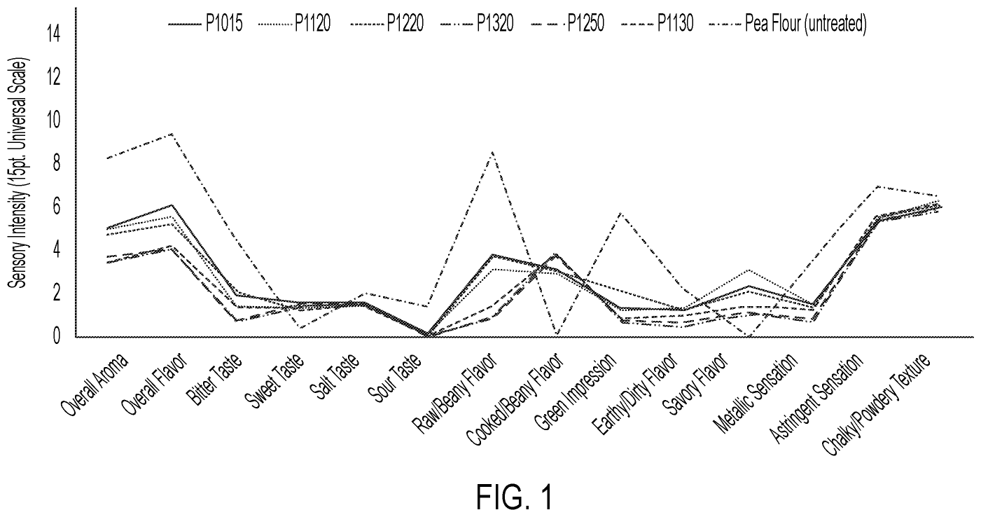

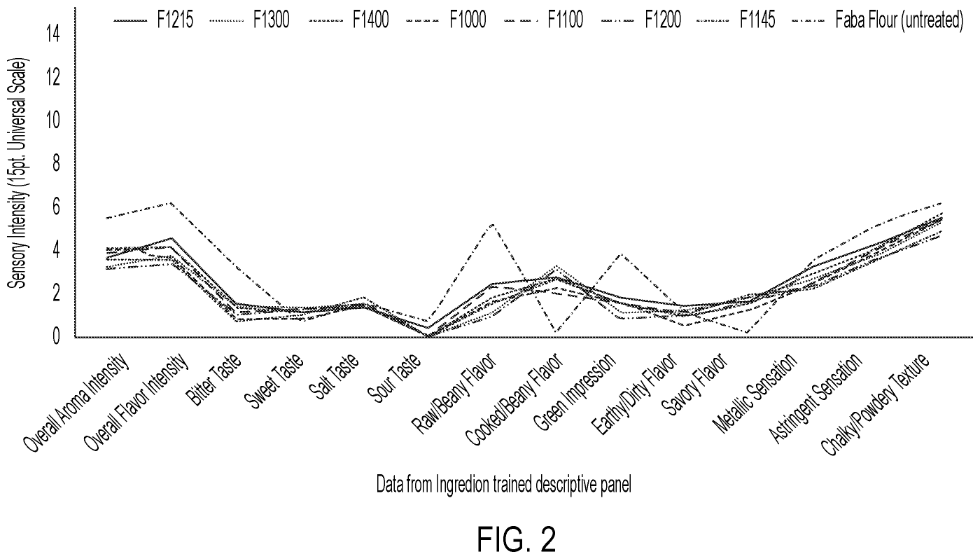

Results for de-flavored pea flour are graphed in FIG. 1 and results for de-flavored fava bean flour are graphed in FIG. 2. In both FIG. 1 and FIG. 2, flavor intensity is on the vertical axis with 0 meaning a flavor attribute was least intense (or not perceived) and 15 meant a flavor attribute was most intense. Flavor attributes are on horizontal axis.

With reference to FIG. 1, all de-flavored pea flour samples had statistically significantly milder and cleaner flavor profiles than untreated base material as reflected by their reduced intensities of bitter taste, raw/green beany, earthy/dirty, and savory flavors. Also as seen, among the treated batches, Batches P1130, P1250 and P1320 had least overall flavor, overall aroma, were least bitter, least raw/green beany, lowest earthy/dirty and savory flavors. In comparison, batches P1015, P1120 and P1220 had the most intense rating of all attributes relative the other treated batches. Note too that the samples in Table 1 are reported in order from generally most intense flavor at the top of the table and least intense at the bottom of the table

With reference to FIG. 2, all de-flavored fava bean flour samples had statistically significantly milder and cleaner flavor profiles than untreated base material as reflected by their reduced intensities of bitter taste, raw/green beany, earthy/dirty, and savory flavors. Note from Table 2 that process conditions selected were less diverse than for pea flour (in part because of experience with pea flour). The more limited set of process conditions is shown in FIG. 2 by reference to the generally smaller difference in flavor attributes among samples. Nevertheless, differences in flavor profile are noticeable among the Batches. As with Table 1, Batches are listed in Table 2 in the order from most intense flavor at the top to least intense flavor at the bottom. This is seen in FIG. 2 as Batch F1145 has flavor intensities closer to zero than Batch F1215.

### EXAMPLE 3—CHARACTERIZATION OF STARCH DAMAGE LEVEL OF PULSE FLOUR

De-flavoring process conditions were further evaluated to assess effect of the de-flavoring process on the base flour. As described in this example, de-flavored legume flours were evaluated damage de-flavored relative to untreated flour and for effect on water holding capacity.

### EXAMPLE 3A—STARCH DAMAGE

Damage to de-flavored flour was evaluated using Differential Scanning calorimetry (DSC) analysis. Damage to both the starch and to the protein was evaluated. Reported starch damage values are gelatinization enthalpy peak for the starch from a de-flavored legume flour and as a percent change between gelatinization enthalpy peak of the starch from the de-flavored flour and an untreated starch of the same time, called “percent damage.” Note that gelatinization enthalpy peaks of starch are known, essentially consistent for a type of starch, and generally different for different types of starch. Percent damage to starch, therefore, can be calculated with reference to reported gelatinization enthalpy peaks or with reference to commercially available pea flours.

DSC process used for measuring starch damage follows. Legume flour, sample for DSC was prepared at 33% w/w in deionized water. Sixty milligrams of prepared sample were loaded into DSC high volume pan. DSC was performed from 20 to 140° C. at a heating rate of 10° C./min using a high-volume pan with deionized water as the reference using a TA Q2000 DSC instrument (TA Instruments). The ratio of starch enthalpy peak of processed pulse flour to that of an untreated pulse flour represents the amount ratio of undamaged starch. The starch damage level was then calculated by subtracting the ratio from one hundred percent. Although measurements were done on flour (including starch and protein), the enthalpies reported in Table 5 correlate to starch gelatinization (instead of protein denaturation) because the high sample solid content and fast temperature ramp so it was too fast for protein to react to the temperature change. Together with the low protein content in flour and low solids content overall, the enthalpy change is essentially all from starch gelatinization.

TABLE 5
Percent Starch Damage of Pea Starch in Pea Flour

| Batch | Starch damage level (%) |
|---|---|
| Pea Flour | 0 |
| (untreated) | |
| P1015 | 49.1 |
| P1120 | 45.7 |
| P1220 | 13.1 |
| P1320 | 65.3 |
| P1250 | 40.4 |
| P1050 | 33.0 |

Note that Batch P1050 was made using the process conditions reported to make Batch P1250. Comparing starch damage in a batch of de-flavored pea flour with the batch's flavor attributes (Compare Table 5 and FIG. 1) it is seen that batches can be highly de-flavored and have limited starch damage (e.g. Batch P1250 and P1050) but that level of starch damage does not predict flavor as the least damaged Batch (P1220) had more intense flavor than Batch P1250 (see FIG. 1). Also the most damaged Batch (P1320) had flavor intensity like Batch 1250.

TABLE 6
Percent Starch Damage of Fava Starch in Fava Bean Flour

| Batch | Percent Starch Damage |
|---|---|
| Fava Bean Flour | 0.00 |
| (untreated) | |
| F1215 | 26.09 |
| F1300 | 32.61 |
| F1400 | 36.96 |
| F1000 | 39.13 |
| F1100 | 26.09 |
| F1200 | 26.09 |
| F1145 | 36.96 |

With reference to Table 6 and FIG. 2 it is seen that de-flavoring conditions can be controlled to obtain both high de-flavoring and limited starch damage, for example Batch F1200 or F1100. It is also seen that starch damage does not predict flavor intensity as the Batch F1145 had the least intense flavor but was more damaged than Batch F1215, which had the most intense flavor profile.

### EXAMPLE 3B: WATER HOLDING CAPACITY

Water holding capacity was determined for de-flavored pea flours, de-flavored fava bean flours and de-flavored lentil flours. Water holding capacity was measured as follows: 1.0 g (dry basis) of the flour was added to a 50 mL tube. 10 mL of DI water was added to the tube and vortexed at high speed for 1-2 minutes, ensuring that there were no lumps or aggregates in the solution. Sample was left to sit at room temperature for 30 minutes. It was then centrifuged at 3000×g for 20 minutes at room temperature. The supernatant was then decanted. The weight of the precipitate was measured and the water holding capacity was calculated as the increase in weight (wet/dry). Results are reported in Table 7 as a ratio (g/g).

TABLE 7
Water Holding Capacity of Legume Flours
and De-flavored Legume Flours

| | Water holding capacity |
|---|---|
| Legume Flour | (g/g) |
| Pea Flour (untreated) | 1.24 |
| De-flavored Pea Flour (P1050) | 2.4 |
| Fava bean flour (untreated) | 2.10 |
| De-flavored Fava Bean Flour | 2.26 |
| (F1145) | |
| De-flavored Fava Bean Flour | 2.19 |
| (F1200) | |
| Lentil flour (untreated) | 2.10 |
| De-flavored Lentil Flour | 2.29 |
| (L0930) | |
| De-flavored Lentil Flour | 2.50 |
| (L1345) | |

As seen samples generally (excepting pea) de-flavored legume flours have water holding capacity like the untreated flour showing that legume flours can be de-flavored to have less intense flavor compared to the untreated flours retaining similar functional performance to the untreated flour.

Considering all de-flavored legume flours, all have water holding capacity between about 2.1 and 2.5 (g/g). Relative to untreated pea flours this shows improvement. But it also shows that the de-flavoring process can be used to standardize the water holding of de-flavored legume flours across legume type.

### EXAMPLE 4—USE OF DE-FLAVORED PEA FLOUR IN COOKIES

Cookies were made using untreated pea flour and de-flavored pea flour (Batch P1050). All cookies included primarily wheat flour. For cookies using legume flour, the legume flour replaced an equal portion of wheat flour (w/w). The formula to make the cookies is reported in Table 8.

TABLE 8
Test Cookie Formula

| | Wheat Flour | | Legume Flour | |
|---|---|---|---|---|
| | Control | | Sample | |
| Ingredient | g | wt. % | g | wt. % |
| Granulated Sugar | 94.5 | 20.07 | 94.5 | 20.07 |
| Nonfat Dry Milk | 2.3 | 0.49 | 2.3 | 0.49 |
| Salt | 2.8 | 0.59 | 2.8 | 0.59 |
| Baking Soda | 2.3 | 0.49 | 2.3 | 0.49 |
| All-purpose shortening | 90 | 19.11 | 90 | 19.11 |
| High-fructose corn syrup 42% | 3.4 | 0.72 | 3.4 | 0.72 |
| Ammonium bicarbonate | 1.1 | 0.23 | 1.1 | 0.23 |
| Distilled water (to be adjusted | 49.5 | 10.51 | 49.5 | 10.51 |
| based on moisture of flour) | | | | |
| Flour, 13% Moisture Basis | 225 | 47.78 | 180 | 38.22 |
| Legume Flour Sample, 13% | 0 | 0 | 45 | 9.56 |
| Moisture Basis | | | | |
| Total: | 470.9 | 100.00 | 470.9 | 100.00 |

Cookies were made as follows. Baking soda, salt, non-fat dry milk, and granulated sugar were weighed and mixed together. Shortening was added to commercial mixing bowl and dry ingredient mix was on top of shortening. Dry ingredients and shortening were mixed for 3 minutes on low speed, scraping every minute to form creamed shortening. High fructose corn syrup (HFCS) and water were mixed in separate vessel, swirled to mix, and then ammonium bicarbonate was added to HFCS-water mixture and swirled to dissolve. Liquid was added to creamed shortening and mixed for 1 minute on low speed, scraped and then mixed for one-minute more on low speed. Flour (wheat and legume flour) were added to the liquid and creamed shortening. All were mixed for 2 minutes on low speed with side scraping every 30 seconds.

Dough was divided into eight relatively equal portions and handling dough as little as possible, each portion was rounded into oblong shape of about 5 cm length. Portions were added to lightly greased baking sheets with gauge strips attached and rolled to thickness with one forward stroke of rolling pin. Dough was cut with 60-mm cookie cutter and excess dough was discarded. Baking sheet was place in in 375° F. (about 190° C.) oven for 11 min. On removal from the oven, cookies were cooled 5 minutes and then removed from the baking sheet.

Cookies were evaluated for hardness using a TA.XT texture analyzer. During test, probe covered a test distance of 15 mm and at test speed of 2.0 mm/s. Ten samples were measured and averaged. Wheat flour cookies (control) had hardness of 1519.22 g. Cookies made using wheat flour and untreated pea flour had hardness of 1898.52 g. Cookies made using wheat flour and de-flavored pea flour had a hardness of 1694.99 g.

### EXAMPLE 5—EVALUATION OF DE-FLAVORED LEGUME FLOURS FOR REDUCTIONS IN VARIOUS VOLATILE CHEMICALS

Effect of the de-flavoring process on the presence of certain volatile compounds associated with causing flavor, aroma or both was evaluated using gas chromatography and mass spectroscopy (GC/MS). Results are presented as the percent change in the area response for defined compounds detected using GC/MS. The percent change compared area response for compounds in untreated base pea flour with de-flavored pea flour. GS/MC process was done as follows.

Extraction of volatile flavor compounds from a sample containing pulse proteins was done using saturated sodium chloride solution and heat. A small amount of deuterated hexanal was added as an internal standard to a headspace vial containing the protein and saturated sodium chloride solution. The vial was incubated while a solid phase microextraction (SPME) fiber adsorbed the volatile compounds from the headspace (Divinylbenzene/Carboxen/Polydimethylsiloxane (DVB/CAR/PDMS) SPME fibers 1 cm (p/n 57298-U)). The fiber was then desorbed into a GC/MS where the eluted volatile compounds were searched against the NIST Mass Spectral Search Program and identities were verified against published NIST retention time indexes. Relative quantitation for each identified compound was then performed using mass spectrometry response versus the internal standard response. A DB-WAX UI (60 m×0.25 mm×0.25 μm) was applied as stationary phase with helium as the carrier gas.

Solutions/Indicators were prepared as follows. Saturated sodium chloride solution was made by placing 250 grams of sodium chloride in a 500 mL container. Fill the remaining container space with de-ionized Milli-Q water. Internal standard was made as follows. Transferred 10 μL of hexanal-d6 into 1 ml of methanol-d4 on the balance in a tared 1.5 mL screw cap vial.

Sample Preparation was a follows. Prepared in duplicate, 2.0 g of protein material or 4 mL of protein solution was weighed into a 20 mL headspace vial with SPME cap. 5 μL of internal standard was added. 4 mL of saturated sodium chloride solution is added to solid samples. If solids are slurries or high moisture approximately 1 g sodium chloride was added instead of the sodium chloride solution. The vial was capped and transfer to instrument tray.

Results for pea flour are reported in Table. Results absolute values are reported in parts-per-million (PPM).

TABLE 9
Percent reduction in area response from Gas Chromatography/Mass
Spectroscopy Between De-Flavored and Untreated Pea Flours

| | | Average | Average | |
|---|---|---|---|---|
| | | Area | Area | |
| | | Response | Response | |
| | | (PPM) | (PPM) | |
| | | (De-flavored | (Untreated | Percent |
| CAS No. | Chemical Name | Pea Flour) | Pea Flour) | Change |
| 75-07-0 | Acetaldehyde | 0.3 | 3.6 | 90.6 |
| 64-17-5 | Ethanol | 0.3 | 2.2 | 85.7 |
| 108-88-3 | Benzene, Methyl- | 0.5 | 1.5 | 65.1 |
| 66-25-1 | Hexanal | 3.5 | 54.6 | 93.7 |
| 1576-95-0 | 2-Penten-1-Ol, | 0.4 | 5.5 | 92.5 |
| | (Z)- | | | |
| 3777-69-3 | Furan, 2-Pentyl- | 0.1 | 3.5 | 96.1 |
| 100-42-5 | Benzene, | 0.1 | 0.8 | 93.1 |
| | Ethenyl- | | | |
| 71-41-0 | 1-Pentanol | 0.7 | 5.0 | 87.1 |
| 124-13-0 | Octanal | 0.0 | 0.4 | 100.0 |
| 20273-24-9 | Cis 2 Pentenol | 0.0 | 0.8 | 95.4 |
| 60784-31-8 | (Z)-Non-2 Enal | 0.0 | 0.6 | 93.5 |
| 110-93-0 | 5-Hepten-2-One, | 0.0 | 21.6 | 99.8 |
| | 6-Methyl- | | | |
| 111-27-3 | 1-Hexanol | 0.2 | 57.0 | 99.6 |
| 124-19-6 | Nonanal | 0.2 | 0.7 | 74.1 |
| 2363-89-5 | 2 Octenal | 0.0 | 0.6 | 100.0 |
| 64-19-7 | Acetic Acid | 0.4 | 1.7 | 75.9 |
| 3391-86-4 | 1-Octen-3-Ol | 0.7 | 1.3 | 48.2 |
| 111-70-6 | 1-Heptanol | 0.1 | 1.5 | 95.1 |
| 111-87-5 | 1-Octanol | 0.1 | 0.4 | 76.5 |
| 30086-02-3 | (3e,5e)-3,5- | 0.0 | 0.2 | 80.0 |
| | Octadien-2-One | | | |
| 503-74-2 | Butanoic Acid, | 0.4 | 0.9 | 52.8 |
| | 3-Methyl- | | | |
| 116-53-0 | Butanoic Acid, | 0.1 | 0.4 | 61.2 |
| | 2-Methyl- | | | |
| 142-62-1 | Hexanoic Acid | 0.1 | 2.8 | 95.3 |
| 143-08-8 | 1-Nonanol | 0.0 | 0.5 | 100.0 |

1. A de-flavored legume flour comprising: a starch and a protein, wherein de-flavored legume flour has a water holding capacity of at least about 1.4 (g/g),
wherein the protein content less than about 30%.

2. The de-flavored legume flour of claim 1: wherein the de-flavored legume flour has a starch damage from 10% to about 50%,
wherein the protein is in an amount no more than essentially equivalent to the protein content of the base legume.

3. (canceled)

4. (canceled)

5. (canceled)

6. (canceled)

7. The de-flavored legume flour of claim 1 being selected from the group consisting of pea, lentil, fava bean, and chickpea.

8. The de-flavored legume flour of claim 1,
wherein the de-flavored pea flour has a percent increase of water holding capacity compared to the untreated pea flour of at least about 75%.

9. The de-flavored legume flour of claim 1 having a percent change in water holding capacity compared to an untreated legume flour from the same base that is less than about 20%;
wherein the de-flavored legume flour is a fava bean flour or lentil flour.

10. The de-flavored legume flour of claim 1 being a de-flavored pea flour and having
a. a percent change starch damage compares an untreated pea flour of less than about 20%,
b. or more of (i) a water holding capacity from about 1.4 to about 2.0 g/g or and (ii) a percent change in water holding capacity compared to an untreated pea flour from the same base that is less than about 20%.

11. The de-flavored legume flour of claim 1 being a fava bean flour having a starch damage from about 20% to about 30%.

12. (canceled)

13. The de-flavored legume flour of claim 1 a having a % reduction of at least 45% (measured using the GC/MS method provided in this specification) of at least one chemical present in an untreated pea protein concentrate wherein, optionally, chemical present in an untreated pea protein concentrated is at least one of acetaldehyde, ethanol, methyl-benzene, hexanal, (z)-2-penten-1-ol, 2-pentyl-furan, ethenyl-benzene, 1-pentanol, octanal, cis 2 pentenol, (z)-non-2 enal, 6-methyl-5-hepten-2-one, 1-hexanol, nonanal, 2 octenal, acetic acid, 1-octen-3-ol, 1-heptanol, 1-octanol, (3e,5e)-3,5-octadien-2-one, 3-methyl-butanoic acid, 2-methyl-butanoic acid, hexanoic acid, 1-nonanol.

14. (canceled)

15. (canceled)

16. (canceled)

17. (canceled)

18. (canceled)

19. (canceled)

20. A method for making a de-flavored legume flour comprising:
a. applying aqueous steam to the untreated legume flour in a ratio (flour to steam) of at least about 10:1 to about 20:1 to obtain a moistened legume flour;
b. heating the moistened legume flour at a temperature from a range selected from the group consisting of:
i. from about 150° C. to about 210° C., from about 160° C. to about 210° C., or from about 170° C. to about 210° C., or from about 175° C. to about 205° C.; and
ii. from about 150° C. to about 205° C. or to about 195° C., or to about 185° C., or to about 175° C., or to about 165° C. 170° C. to about 210° C., or from about 180° C. to about 200° C.; and
iii. from about from about 175° C. to about 205° C., or about 175° C. to about 195° C. or about 175° C. to about 185° C.

21. The method of claim 20 wherein the heating is for a time from about 1 to 2 minutes to obtain a de-flavored legume flour.

22. The method of claim 20 further comprising drying the de-flavored legume flour to a moisture content from about 4% to about 15% (wt. %) with an air flow having a temperature from about 140° C. to about 160° C.

23. The method of claim 20 further comprising, applying liquid water or aqueous solution to the untreated legume flour in a ratio (flour to water) greater than about 4.4:1.

24. (canceled)

25. The method of claim 20 wherein the applying step and heating step occurs in a hollow tube of a hollow tube reactor, the reactor further comprising a rotor within the hollow tube of the hollow-tube reactor; and
wherein the rotor is rotated at a rate less than about 700.

26. (canceled)

27. The method of claim 20 further comprising drying the de-flavored legume flour to a moisture content from about 4% to about 15% (wt. %) in a hollow tube of a hollow-tube reactor, the reactor further comprising a rotor within the hollow tube of the hollow-tube reactor:
wherein the drying is done at least in part by passing air having a temperature from about 140° C. to about 160° C.; and
wherein the rotor is rotated at a rate of from about 300 to about 700.

28. The method of claim 20 wherein the applying step and heating step are done in a first hollow-tube reactor and the de-flavored legume flour is dried in a second hollow-tube reactor.

29. (canceled)

30. (canceled)

31. (canceled)

32. (canceled)

33. (canceled)

34. (canceled)

35. (canceled)

36. A food composition comprising: a) a de-flavored legume flour wherein the de-flavored legume flour comprises a starch and a protein, and wherein de-flavored legume flour has a water holding capacity of at least about 1.4 (g/g) and b) a second edible ingredient.

37. The food composition of claim 36 wherein the food composition, is gluten free food composition.

38. The food composition of claim 36 further comprising a wheat flour used in a ratio (de-flavored legume flour to wheat flour) of from about 1:1 to about 1:5.

39. The food composition of claim 36 being a baked good comprising a flour component that consists of all the flour within the baked good, and wherein the flour component comprises the de-flavored legume flour in an amount of at least about 10%.

40. The food composition of claim 36 being a baked good comprising a flour component that consists of all of the flour within the bake good, and wherein the flour component consists of de-flavored legume flour and wheat flour and wherein the de-flavored legume flour is used in the flour component in an amount from about 10% to about 50%.

41. (canceled)
